(19) United States
(12) Patent Application Publication
(10) Pub. No.: US 2018/0345856 A1
(43) Pub. Date: Dec. 6, 2018

(54) Lighting Module of a Vehicle

(71) Applicant: Bayerische Motoren Werke Aktiengesellschaft, Muenchen (DE)

(72) Inventors: Tom Willmann, Muenchen (DE); Florian Altinger, Shenyang/Heping District (CN)

(21) Appl. No.: 16/058,707

(22) Filed: Aug. 8, 2018

Related U.S. Application Data
(63) Continuation of application No. PCT/EP2017/052115, filed on Feb. 1, 2017.

(30) Foreign Application Priority Data
Feb. 9, 2016 (DE) 10 2016 201 882.5

(51) Int. Cl. B60Q 3/60; B60Q 3/82; B60Q 3/74

(52) U.S. Cl. CPC B60Q 3/60; B60Q 3/74; B60Q 3/82

(57) ABSTRACT

A light-emitting module of a vehicle includes a light-emitting element for emitting light, a reflector for bundling the light emitted by the light-emitting element, and a cover for covering the light-emitting element and the reflector. At least one visible part of the reflector projects through at least one visible opening of the cover.

### CROSS REFERENCE TO RELATED APPLICATIONS

This application is a continuation of PCT International Application No. PCT/EP2017/052115, filed Feb. 1, 2017, which claims priority under 35 U.S.C. § 119 from German Patent Application No. 10 2016 201 882.5, filed Feb. 9, 2016, the entire disclosures of which are herein expressly incorporated by reference.

### BACKGROUND AND SUMMARY OF THE INVENTION

The present invention relates to a light-emitting module of a vehicle. The invention additionally relates to a vehicle comprising such a light-emitting module. The light-emitting module is particularly advantageously an interior lamp.

Light-emitting modules for vehicles are known from the prior art. Such light-emitting modules can be, for example, interior lamps or reading lights. The prior art here discloses light-emitting modules that have silver-colored reflectors for bundling light. In this way, the light that is produced by a light-emitting means is guided in a desired direction. Defined areas within the vehicle are thus illuminated.

In order to improve the optical appearance of such reading lights, they are often provided with decorative trims. Such decorative trims can comprise, for example, painted trims or chrome trims. In this way, an optically high-quality impression is achieved.

However, it is a disadvantage that such trims must be realized by way of an additional component. This additional component is typically made of plastics and as a result must be coated and/or painted. Coating and/or painting of components is very costly.

It is therefore an object of the invention to provide a light-emitting module which is simple and cheap to produce and to mount.

The object is thus achieved by way of a light-emitting module that comprises a light-emitting means, a reflector and a cover. The light-emitting module is in particular part of a vehicle and/or suitable for use in a vehicle. The light-emitting means serves for emitting light. The light-emitting means can be an incandescent lamp, a light-emitting diode or another light-emitting component. The reflector is embodied for bundling the light emitted by the light-emitting means. It is thus possible with the reflector in particular to define a region that is intended to be illuminated by the light-emitting module. Finally, the cover is intended for covering at least the light-emitting means and the reflector. The cover is advantageously light-transmissive such that the light produced by the light-emitting means can pass through the cover. The light-emitting means and the reflector are particularly advantageously arranged in a housing, wherein the cover closes the housing, in particular completely. Provision is made according to the invention for at least one visible part of the reflector to penetrate the cover at least one visible opening. Provision is thus in particular made for the cover to have at least one visible opening, with the visible part protruding through the visible opening. The visible opening is here filled, particularly advantageously completely, by the visible part of the reflector. Consequently, the cover has, by way of the visible part, a decorative trim, wherein the decorative trim is formed by the reflector itself. This simplifies the production of the light-emitting module, since in particular no additional coated parts are required. Due to the additional use of the reflector as the decorative element, only the coating of one component, namely the reflector, is necessary to obtain an optically high-quality appearance. Provision is made here for the visible opening to comprise a through-opening or alternatively a multiplicity of separate openings. Provision is in particular thus made for the visible part of the reflector to penetrate the cover in one or more places.

The light-emitting module advantageously has a switch element. The light-emitting means of the light-emitting module is in particular actuatable with the switch element. Provision is furthermore made for the switch element to be at least partially framed by the visible part. Consequently, the appearance of the switch element is optically improved by a decorative trim, and at the same time a search aid for a user is provided, who can quickly and easily find the switch element due to the visible parts of the reflector that act as decorative parts at the switch elements. If a plurality of switch elements are provided, provision is made for the visible part of the reflector to at least partially frame all switch elements together. In another alternative, provision is made for the visible part to at least partially frame each switch element individually.

The visible part is preferably embodied to be flush with a surface of the cover. This gives a planar surface of the cover, which is not disturbed by unevenness due to the visible part. For a user, this thus gives the impression of a decorative element that is embedded in the cover, wherein a user is in particular not able to optically distinguish whether the decorative element is a separate element or part of the reflector. As a result, an optically high-quality impression that is similar to light-emitting modules of the prior art is given, while the production costs and the production complexity are at the same time minimized. In another alternative, the visible part is embodied such that it projects beyond the surface of the cover or recedes below the surface of the cover. This provides a haptic orientation aid for a user, in particular when the visible part at least partially frames at least one switch element, while the visible part can at the same time be integrated in many ways in an already existing design of the vehicle due to its projection or recession with respect to the surface of the cover.

The reflector is advantageously a surface-coated plastics element. Provision is made here in particular for the reflector to be a painted and/or galvanized and/or powder-coated and/or PVD coated plastics part. The entire reflector is advantageously coated with the same material. The surface coating of the reflector in particular permits reflection of light. Consequently, light that is emitted by the light-emitting means is able to be reflected by the reflector due to the surface coating.

In a preferred embodiment of the invention, a surface finish of the visible part is different from that of the remaining reflector. Provision is made in particular here for the reflector to be a coated plastics element. Consequently, provision is made for different coatings to be provided due to different surface finishes of the plastics element. For example, the surface finish can in particular result in a glossy or matte surface. Due to the glossy and/or matte surface of the plastics element, the coated surface is also glossy and/or matte. In an alternative embodiment, the reflector is surface-finished after the surface coating, such that the visible part again has a different surface finish from the remaining reflector. In a different alternative embodiment, the surface finish of the visible part is identical to that of the remaining reflector.

The visible part is particularly advantageously a touch-sensitive surface. The light-emitting means is in particular actuatable via the touch-sensitive surface. In this case, provision is made for the visible part to penetrate the cover over a large area, such that a surface is present that can be operated by a user. A user can advantageously actuate the light-emitting means via the touch-sensitive surface.

The visible part is in particular able to be backlit by the light-emitting means. Provision is made here for the visible part to have a material thickness such that a predefined luminous intensity of the backlighting due to the light-emitting means is present. In this way, it is possible to achieve an optically high-quality appearance, while, in the case in which the visible part at least partially frames at least one switch element, the backlighting of at least the visible part permits quick and reliable finding of the switch element, in particular if no ambient illumination or low ambient illumination is present.

In a further preferred exemplary embodiment of the invention, the visible part comprises a symbolic representation. The symbolic representation can particularly also be arranged on a switch element of the light-emitting module. The symbolic representation is particularly advantageously backlit, as described above. Due to the symbolic representation, operating of the light-emitting module, in particular operating of switch elements of the light-emitting module, is therefore made simple and intuitive.

The reflector is preferably formed in one piece. Consequently, only one element needs to be provided, which is in particular surface-coated. This one element is used as a reflector and also as a decorative element. This is achieved by the visible part of the reflector protruding through at least one visible opening in the cover.

Finally, the invention relates to a vehicle. The vehicle comprises a light-emitting module as described above. Provision is advantageously made here for the light-emitting module to be an interior lamp of the vehicle. The light-emitting module is consequently advantageously a panorama roof light and/or a rear-seat roof light and/or a driver reading lamp and/or a passenger reading lamp.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic sectional view of a light-emitting module in accordance with a first exemplary embodiment of the invention;

FIG. 2 shows a schematic depiction of the light-emitting module in accordance with the first exemplary embodiment of the invention;

FIG. 3 shows a schematic sectional view of a light-emitting module in accordance with a second exemplary embodiment of the invention;

FIG. 4 shows a schematic depiction of the light-emitting module in accordance with the second exemplary embodiment of the invention; and

FIG. 5 shows a schematic depiction of a vehicle in accordance with an exemplary embodiment of the invention.

### DETAILED DESCRIPTION OF THE DRAWINGS

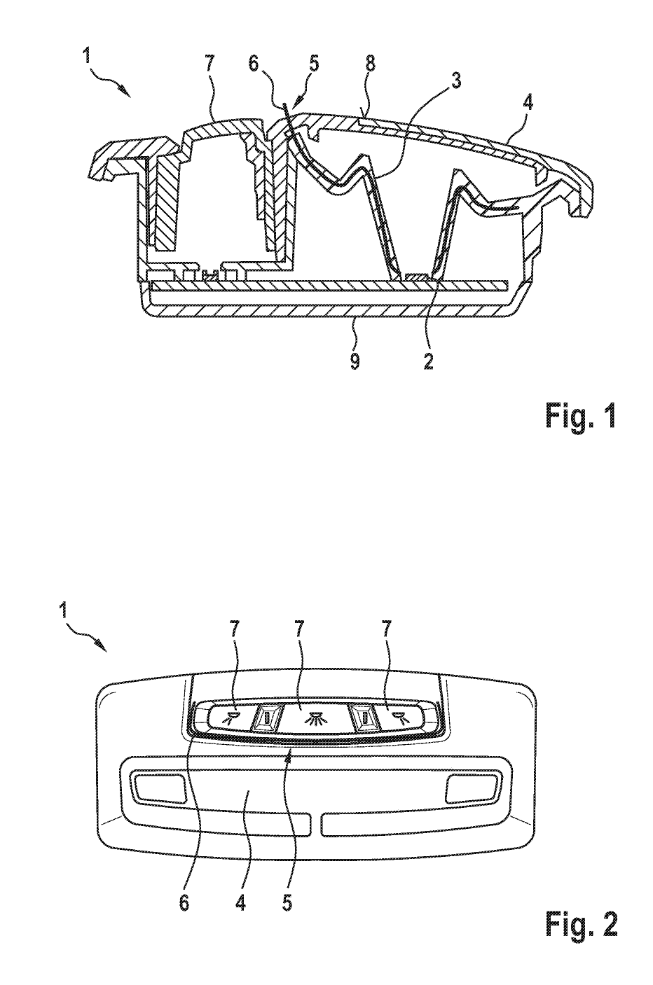

FIG. 1 schematically shows a light-emitting module 1 in accordance with a first exemplary embodiment of the invention. FIG. 1 here shows a sectional view through the light-emitting module 1.

FIG. 2 shows a top view of the same light-emitting module 1 in accordance with the first exemplary embodiment of the invention.

The light-emitting module 1 comprises a light-emitting means 2 and a reflector 3. The light-emitting means 2 and the reflector 3 are here arranged in a housing 9. A cover 4 closes the housing 9, such that the cover 4 covers the reflector 3 and the light-emitting means 2.

The light-emitting means 2 in the first exemplary embodiment is a light-emitting diode. Alternatively, a different light-emitting element, such as a fluorescent tube, an organic light-emitting diode, a laser light-emitting diode, an incandescent lamp or other light producing means can be used. The reflector 3 is a plastics element having a surface coating. Due to the shaping of the reflector 3, the light that is emitted by the light-emitting means 2 is able to be bundled and guided onto a predefined area outside the light-emitting module. As a result, a predefined area is able to be illuminated with the light-emitting module 1. Provision is made particularly advantageously for the light-emitting module 1 to have a plurality of light-emitting means 2, which are able to be switched on and off independently from one another, wherein the reflector 3 is shaped such that different regions outside the light-emitting module 1 can be irradiated independently from one another.

The reflector 3 has a surface coating. The surface coating is advantageously a paint or a galvanically applied overcoat or a PVD coating, which improves reflection of light that is emitted by the light-emitting means 2. The reflector 3 is here embodied, depending on the application, such that it has optionally matte and glossy surfaces. It is thus possible to guide light from the light-emitting means 2 diffusely over a large area or alternatively in concentrated fashion onto individual light points.

In order to not only improve an outer appearance of the light-emitting module 1, but also to accentuate switch elements 7 of the light-emitting module 1, provision is made for the cover 4 to have a visible opening 5. At the visible opening 5, a visible part 6 of the reflector 3 protrudes through the cover 4. The visible opening 5 in particular comprises a slit through which the visible part 6 of the reflector 3 protrudes. Provision is made in the exemplary embodiment shown in FIG. 1 for the visible part 6 to project beyond the surface 8 of the cover 4. In an alternative embodiment, the visible part 6 is embodied to be planar with the surface 8 of the cover 4.

As can be seen in particular from FIG. 2, the visible opening 5 is arranged such that the visible part 6 partially frames all switch elements 7 of the light-emitting module 1 together. Consequently, the visible part 6 not only acts as a decorative element that improves the optical impression of the light-emitting module 1, but the visible part 6 is also a search aid for a user who wishes to operate the switch elements 7.

The reflector 3 is embodied in one piece, with the result that in particular the visible part 6 is also embodied in one piece with the remaining reflector 3. As a result, a single element is present within the light-emitting module 1, which must have a surface coating. Due to the surface coating of the reflector 3, firstly, a decorative element is realized, and secondly, the light that is emitted by the light-emitting means 2 is able to be bundled and guided onto a predefined region.

The surface coating is identical in particular for the entire reflector 3. Provision is also made here for the reflector 3 to have a surface finish, wherein the surface finish of the visible part 6 is different from the surface finish of the remaining reflector 3. As an example, in particular the surface finish of the visible part 6 is designed as per a decorative element, while the remaining reflector 3 has a surface finish that is designed for optimum reflection of light. When applying the surface coating, provision is made in particular for the surface finish to be retained, such that the surface coating also has different properties.

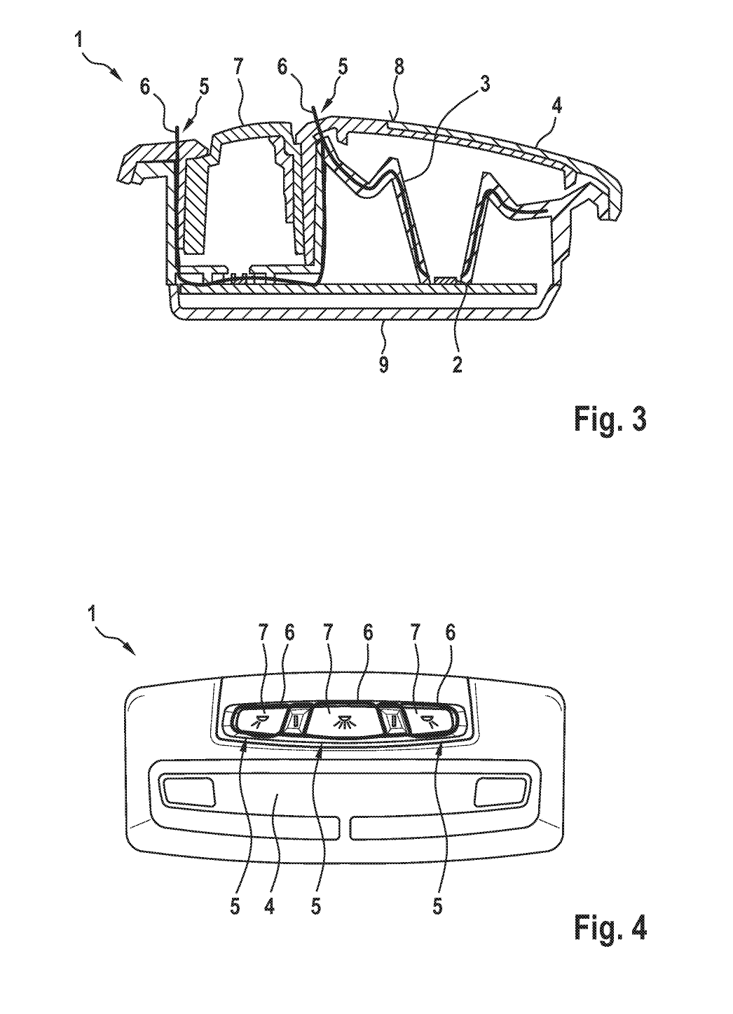

FIG. 3 schematically shows a light module 1 in accordance with a second exemplary embodiment of the invention. Here, FIG. 3 shows a sectional view through the light-emitting module 1. FIG. 4 in turn shows a top view of the light-emitting module 1 in accordance with the second exemplary embodiment of the invention.

In principle, the light-emitting module 1 in accordance with the second exemplary embodiment of the invention is identical to the light-emitting module 1 in accordance with the first exemplary embodiment of the invention. The light-emitting module 1 in accordance with the second exemplary embodiment only differs from the light-emitting module 1 in accordance with the first exemplary embodiment by way of the visible opening 5 and the reflector 3. Specifically, the reflector 3 in the light-emitting module 1 in accordance with the second exemplary embodiment is enlarged, such that the switch elements 7 of the light-emitting module 1 are individually framed completely by the visible part 6 of the reflector 3. In this way, each individual switch element 7 is individually accentuated with a decorative element by the respective visible region 6 of the reflector 3. Due to the reflector 3 having changed as compared to the first exemplary embodiment, the visible opening 5 has also changed and comprises overall three separate openings, wherein each of the separate openings frames a switch element 7. Otherwise, the setup of the reflector 3 in the light-emitting module 1 in accordance with the second exemplary embodiment corresponds to the setup of the reflector 3 of the light-emitting module 1 in accordance with the first exemplary embodiment of the invention.

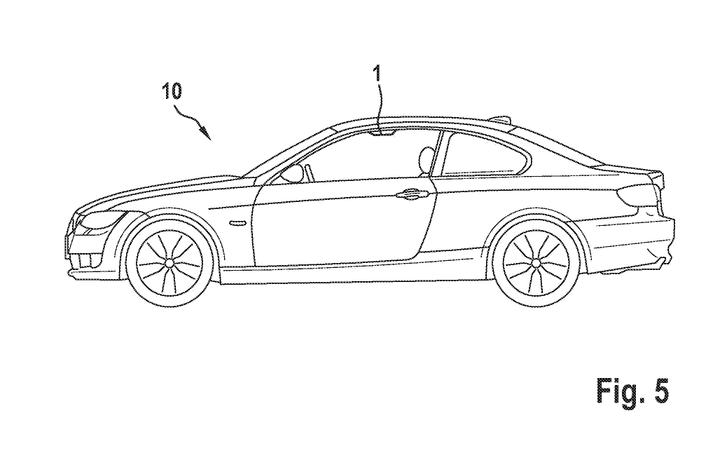

FIG. 5 finally shows a vehicle 10, which has a light-emitting module 1 in accordance with the first exemplary embodiment or the second exemplary embodiment. The light-emitting module 1 is here in particular a roof light, which can advantageously light different regions of the interior of the vehicle 10. Due to the use of the reflector 3, not only for bundling and guiding light, but also as a decorative element, the light-emitting module 1 is able to be produced easily and cost-effectively.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS:

1 light-emitting module
2 light-emitting means
3 reflector
4 cover
5 visible opening
6 visible part
7 switch element
8 surface
9 housing
10 vehicle

What is claimed is:

1. A light-emitting module of a vehicle, comprising:
a light-emitting element, wherein the light-emitting element emits light;
a reflector, wherein the reflector bundles the light emitted by the light-emitting element; and
a cover, wherein the cover covers the light-emitting element and the reflector;
wherein a visible part of the reflector protrudes through a visible opening of the cover.

2. The light-emitting module as claimed in claim 1, further comprising a switch element, wherein the switch element is at least partially framed by the visible part.

3. The light-emitting module as claimed in claim 1, wherein the visible part is flush with a surface of the cover.

4. The light-emitting module as claimed in claim 2, wherein the visible part is flush with a surface of the cover.

5. The light-emitting module as claimed in claim 1, wherein the reflector is a surface-coated plastics element.

6. The light-emitting module as claimed in claim 2, wherein the reflector is a surface-coated plastics element.

7. The light-emitting module as claimed in claim 3, wherein the reflector is a surface-coated plastics element.

8. The light-emitting module as claimed in claim 1, wherein a surface finish of the visible part of the reflector differs from a surface finish of another part of the reflector.

9. The light-emitting module as claimed in claim 2, wherein a surface finish of the visible part of the reflector differs from a surface finish of another part of the reflector.

10. The light-emitting module as claimed in claim 3, wherein a surface finish of the visible part of the reflector differs from a surface finish of another part of the reflector.

11. The light-emitting module as claimed in claim 1, wherein the visible part is a touch-sensitive surface and wherein the light-emitting element is actuatable via the touch-sensitive surface.

12. The light-emitting module as claimed in claim 2, wherein the visible part is a touch-sensitive surface and wherein the light-emitting element is actuatable via the touch-sensitive surface.

13. The light-emitting module as claimed in claim 3, wherein the visible part is a touch-sensitive surface and wherein the light-emitting element is actuatable via the touch-sensitive surface.

14. The light-emitting module as claimed in claim 5, wherein the visible part is a touch-sensitive surface and wherein the light-emitting element is actuatable via the touch-sensitive surface.

15. The light-emitting module as claimed in claim 8, wherein the visible part is a touch-sensitive surface and wherein the light-emitting element is actuatable via the touch-sensitive surface.

16. The light-emitting module as claimed in claim 1, wherein the visible part is backlightable by the light-emitting element.

17. The light-emitting module as claimed in claim 1, wherein the visible part is a symbolic representation.

18. The light-emitting module as claimed in claim 1, wherein the reflector is formed in one piece.

19. A vehicle, comprising:
a light-emitting module, wherein the light-emitting module includes:
a light-emitting element, wherein the light-emitting element emits light;
a reflector, wherein the reflector bundles the light emitted by the light-emitting element; and
a cover, wherein the cover covers the light-emitting element and the reflector;
wherein a visible part of the reflector protrudes through a visible opening of the cover;
wherein the light-emitting module is an interior light of the vehicle.

20. The vehicle as claimed in claim 19, wherein the visible part is a touch-sensitive surface and wherein the light-emitting element is actuatable via the touch-sensitive surface.
